(19) United States
(12) Patent Application Publication
(10) Pub. No.: US 2015/0074738 A1
(43) Pub. Date: Mar. 12, 2015

(54) METHOD AND APPARATUS FOR INSERTING INFORMATION INTO MULTIMEDIA DATA

(71) Applicants: Elran Ahronee, Alfei Menashe (IL); Gal Gubesi, Alfei Menashe (IL); Gal Sont, Alfei Menashe (IL)

(72) Inventors: Elran Ahronee, Alfei Menashe (IL); Gal Gubesi, Alfei Menashe (IL); Gal Sont, Alfei Menashe (IL)

(21) Appl. No.: 14/389,798

(22) PCT Filed: Apr. 3, 2013
(86) PCT No.: PCT/IL2013/050317

§ 371 Date: Oct. 1, 2014

Related U.S. Application Data
(60) Provisional application No. 61/619,945, filed on Apr. 4, 2012.

(51) Int. Cl. H04N 21/235; H04N 21/242; H04N 21/43; H04N 21/435

(52) U.S. Cl. CPC H04N 21/2353; H04N 21/435; H04N 21/242; H04N 21/4307
USPC 725/114

(57) ABSTRACT

A method of inserting information into multi-media data, the method constituted of: retrieving multimedia data from at least one multimedia storage device; extracting identifying parameters from the retrieved multimedia data; responsive to the extracted identifying parameters, identifying a particular one of a plurality of accompanying records associated with the retrieved multimedia data; creating synchronization information for the identified accompanying record; inserting the identified particular accompanying record into the retrieved multimedia data responsive to the created synchronization information; and outputting the retrieved multimedia data comprising the inserted identified particular accompanying record.

### BACKGROUND OF THE INVENTION

The invention relates generally to the field of video data streams and in particular to a method and apparatus for inserting information into a video data stream.

Video entertainment, such as TV shows and home viewed movies, has been very popular for several decades. In recent years, with the advancement of transmission technologies, particularly satellite and cable broadcast technologies, and the development of the Internet, consumers have been exposed to a wide variety of video entertainment sources from all over the world. However, a consumer may not understand the language of the video entertainment coming from a different country. Traditionally, subtitles or dubbing have been supplied with video entertainment destined for a country whose primary language differs from the language of the video entertainment.

Unfortunately, several disadvantages exist in the current system, such as: consumers may connect to a video entertainment source which is located in a different country and does not supply subtitles or dubbing in the language of the country of the consumer; even if subtitles or dubbing are supplied in the primary language of the country of the consumer, the consumer may prefer a different language; the video presentation may be provided with one of subtitles and dubbing and the consumer prefers the one that wasn't provided; and in order to receive any type of translation, the consumer usually needs to have a subscription or other financial commitment with the provider of the particular video presentation. Additionally, data other than subtitles may be desired by the consumer, the desired data typically not being supplied by the provider of the video presentation. For example, commentary produced by other consumers may be desired to be embedded within the video presentation instead of the subtitles or dubbing supplied by the provider of the video presentation.

User created accompanying records, such as subtitles in a plurality of languages, typically are found on the Internet, however it is not possible to display any of these accompanying records unless a consumer is in possession of the entire file of the particular video presentation and has sufficient knowledge and means to insert the accompanying record into the video presentation. In the event a consumer is viewing a video presentation from a multimedia data provider, typically the video presentation is being viewed contemporaneously with its reception, such as a broadcast displayed on a TV or a web site providing online viewing. In such a case, accompanying records cannot be inserted into the incoming video presentation by the user.

### SUMMARY OF THE INVENTION

Accordingly, it is a principal object of the present invention to overcome at least some of the disadvantages of present and prior art methods of inserting information into a video data stream.

This is accomplished in certain embodiments by providing a system arranged to insert information into multimedia data. In one embodiment, the multimedia data comprises a video data stream and the system comprises: at least one electronic device in communication with a database having stored thereon a plurality of accompanying records, the at least one electronic device arranged to receive the video data stream, the at least one electronic device comprising an output module; an extracting functionality arranged to extract identifying parameters from the received video data stream; an identifying functionality arranged to, responsive to the extracted identifying parameters, identify a particular one of the plurality of accompanying records associated with the received video data stream; a time marker functionality arranged to determine a time marker for the received video data stream; a synchronization functionality arranged to create synchronization information responsive to the determined time marker; and an insertion functionality arranged to insert the identified particular accompanying record into the received multimedia data stream responsive to the created synchronization information, wherein the output module is arranged to output the received multimedia data stream comprising the inserted accompanying record, and wherein the extraction of identifying parameters, the identification of the particular accompanying record, the periodic determination, the creation of synchronization information, and the insertion of the identified particular accompanying record and the outputting are contemporaneous with the receiving.

In one embodiment, the system further comprises a server, the server comprising the database, wherein the communication with database comprises communication with the server. In one further embodiment, the at least one electronic device comprises a plurality of electronic devices, the system further comprising a user synchronization adjustment functionality arranged to: receive a user input from a first of the plurality of electronic devices; and adjust the temporal position of the inserted accompanying records in the received video stream of a second of the plurality of electronic devices responsive to the received user input, the second of the plurality of electronic devices different from the first of the plurality of electronic devices.

In one independent embodiment, a non-transitory computer readable medium is provided, the non-transitory computer readable medium having instructions stored thereon, which, when executed by one or more processors, causes the one or more processors to perform operations, the operations comprising: retrieving multimedia data from at least one multimedia storage device; extracting identifying parameters from the retrieved multimedia data; responsive to the extracted identifying parameters, identifying a particular one of a plurality of accompanying records associated with the retrieved multimedia data; creating synchronization information for the identified accompanying record; inserting the identified particular accompanying record into the retrieved multimedia data responsive to the created synchronization information; and outputting the retrieved multimedia data comprising the inserted identified particular accompanying record.

In one embodiment, the multimedia data comprises a multimedia data stream being received by the at least one multimedia storage device, wherein the extracting identifying parameters, the identifying the particular one of the plurality of accompanying records, the creating synchronization information, the inserting and the outputting are contemporaneous with the receiving of the multimedia data stream by the at least one multimedia storage device. In another embodiment, the at least one multimedia storage device comprises a first multimedia storage device and a second multimedia storage device different from the first multimedia storage device, the retrieving comprising retrieving multimedia data from each of the first and second multimedia storage devices, the operations further comprising: receiving a user input from an electronic device, the electronic device comprising the first multimedia storage device; and adjusting the temporal position of the inserted accompanying record in the retrieved multimedia data from the second multimedia storage device responsive to the received user input.

In one embodiment, the operations further comprise receiving a time marker for the retrieved multimedia data, and wherein the creating synchronization information is responsive to the received time marker. In another embodiment, the operations further comprise determining a time marker for the retrieved multimedia data, and wherein the creating synchronization information is responsive to the determined time marker.

In one further embodiment, the retrieved multimedia data comprises embedded display information and wherein the determining the time marker is responsive to the embedded display information. In another further embodiment, the determining a time marker is performed periodically.

In one embodiment, the retrieved multimedia data comprises a video presentation, wherein in the event the video presentation is interrupted with material not of the video presentation, the operations further comprise: identifying the interruption in the video presentation; interrupting the inserting of the identified particular accompanying record into the retrieved multimedia data responsive to the identified interruption; identifying the resumption of the video presentation; and resuming the inserting of the identified particular accompanying record responsive to the identified resumption. In another embodiment, the operations further comprise receiving information associated with the at least one multimedia storage device, wherein the identifying the particular one of the plurality of accompanying records is further responsive to the received information associated with the at least one multimedia storage device.

In one embodiment, the retrieved multimedia data comprises embedded electronic program guide information and wherein the extracting identifying parameters from the retrieved multimedia data comprises extracting a portion of the embedded electronic program guide information.

In another independent embodiment, a method of inserting information into multimedia data is provided, the method comprising: retrieving multimedia data from at least one multimedia storage device; extracting identifying parameters from the retrieved multimedia data; responsive to the extracted identifying parameters, identifying a particular one of a plurality of accompanying records associated with the retrieved multimedia data; creating synchronization information for the identified accompanying record; inserting the identified particular accompanying record into the retrieved multimedia data responsive to the created synchronization information; and outputting the retrieved multimedia data comprising the inserted identified particular accompanying record.

In one embodiment, the multimedia data comprises a multimedia data stream being received by the at least one multimedia storage device, wherein the extracting identifying parameters, the identifying the particular one of the plurality of accompanying records, the creating synchronization information, the inserting and the outputting are contemporaneous with the receiving of the multimedia data stream by the at least one multimedia storage device. In another embodiment, the at least one multimedia storage device comprises a first multimedia storage device and a second multimedia storage device different from the first multimedia storage device, the retrieving comprising retrieving multimedia data from each of the first and second multimedia storage devices, the method further comprising: receiving a user input from an electronic device, the electronic device comprising the first multimedia storage device; and adjusting the temporal position of the inserted accompanying record in the retrieved multimedia data from the second multimedia storage device responsive to the received user input.

In one embodiment, the method further comprises: receiving a time marker for the retrieved multimedia data, wherein the creating synchronization information is responsive to the received time marker. In another embodiment, the method further comprises: determining a time marker for the retrieved multimedia data, wherein the creating synchronization information is responsive to the determined time marker.

In one further embodiment, the retrieved multimedia data comprises embedded display information and wherein the determining the time marker is responsive to the embedded display information. In another further embodiment, the determining a time marker is performed periodically.

In one embodiment, the retrieved multimedia data comprises a video presentation and wherein in the event the video presentation is interrupted with material not of the video presentation, the method further comprises: identifying the interruption in the video presentation; interrupting the inserting of the identified particular accompanying record into the retrieved multimedia data responsive to the identified interruption; identifying the resumption of the video presentation; and resuming the inserting of the identified particular accompanying record responsive to the identified resumption. In another embodiment, the method further comprises: receiving information associated with the at least one multimedia storage device, wherein the identifying the particular one of the plurality of accompanying records is further responsive to the received information associated with the at least one multimedia storage device.

In one embodiment, the retrieved multimedia data comprises embedded electronic program guide information and wherein the extracting identifying parameters from the retrieved multimedia data comprises extracting a portion of the embedded electronic program guide information.

In one independent embodiment, a system arranged to insert information into multimedia data is provided, the system comprising: a retriever in communication with at least one multimedia storage device having stored thereon multimedia data, the retriever arranged to retrieve multimedia data from the at least one multimedia storage device; an extractor arranged to extract identifying parameters from the retrieved multimedia data; an identifier in communication with an accompanying record storage device having stored thereon a plurality of accompanying records, the identifier arranged to, responsive to the extracted identifying parameters, identify a particular one of the plurality of accompanying records associated with the retrieved multimedia data, wherein the timing relationship between the identified accompanying record and the retrieved multimedia data is unknown; a synchronizer arranged to create synchronization information for the identified accompanying record; an inserter arranged to insert the identified particular accompanying record into the retrieved multimedia data responsive to the created synchronization information; and an output module arranged to output the retrieved multimedia data comprising the inserted accompanying record.

In one embodiment, the system further comprises: a processor; a memory, having instructions stored thereon, wherein the processor is arranged to execute the instructions stored on the memory thereby performing the operations of one of the retriever, extractor, identifier, synchronizer, inserter and output module. In another embodiment, the multimedia data comprises a multimedia data stream being received by the at least one multimedia storage device, wherein the extraction of identifying parameters, the identification of the particular accompanying record, the creation of synchronization information, and the insertion of the identified particular accompanying record and the outputting are contemporaneous with the receiving of the multimedia data stream by the at least one multimedia storage device.

In one embodiment, the system further comprises: a server comprising the accompanying record storage device, wherein the communication with the accompanying record storage device comprises communication with the server. In one further embodiment, the at least one multimedia storage device comprises a plurality of multimedia storage devices, the system further comprising: a plurality of electronic devices, each electronic device comprising a particular one of the plurality of the multimedia storage devices; and a user synchronizer arranged to: receive a user input from a first of the plurality of electronic devices; and adjust the temporal position of the inserted accompanying record in the received video stream of a second of the plurality of electronic devices responsive to the received user input, the second of the plurality of electronic devices different from the first of the plurality of electronic devices.

In one embodiment, the retriever is arranged to retrieve from the at least one multimedia storage device a time marker for the retrieved multimedia data, and wherein the synchronizer is responsive the retrieved time marker. In another embodiment, the system further comprises: a time marker determiner arranged to determine a time marker for the retrieved multimedia data, wherein the synchronizer is responsive to the determined time marker.

In one embodiment, the retrieved multimedia data comprises embedded display information and wherein the time marker determiner is responsive to the embedded display information. In one further embodiment, the time marker determiner is arranged to periodically determine the time marker for the received video data stream.

In one embodiment, the retrieved multimedia data received multimedia data stream comprises a video presentation and wherein the system further comprises: an interrupter; and a resumer, wherein in the event the video presentation is interrupted with material not of the video presentation the interrupter is arranged to: identify the interruption in the video presentation; and interrupt the insertion of the identified particular accompanying record into the retrieved multimedia data, and wherein at the cessation of the interruption of the video presentation, the resumer is arranged to: identify the cessation of the interruption in the video presentation, and resume the insertion of the identified particular accompanying record into the retrieved multimedia data. In another embodiment, the retrieved multimedia data comprises embedded electronic program guide information and wherein the extractor is arranged to extract a portion of the embedded electronic program guide information.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1A illustrates a high level block diagram of a first embodiment of a system arranged to insert accompanying information into a multimedia data stream of an electronic device, according to certain embodiments;

FIG. 1B illustrates a high level block diagram of the system of FIG. 1A comprising a plurality of electronic devices, according to certain embodiments;

FIG. 1C illustrates a high level flow chart of the operation of the system of FIGS. 1A-1B;

FIG. 2 illustrates a high level block diagram of a second embodiment of a system arranged to insert accompanying information into a multimedia data stream of an electronic device, according to certain embodiments;

FIG. 3A illustrates a high level block diagram of a system arranged to insert accompanying information of an accompanying record into a multimedia data file, according to certain embodiments;

FIG. 3B illustrates a high level flow chart of the operation of the system of FIG. 3A; and

FIG. 4 illustrates a high level schematic diagram of system arranged to insert accompanying information into multimedia data, according to certain embodiments.

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

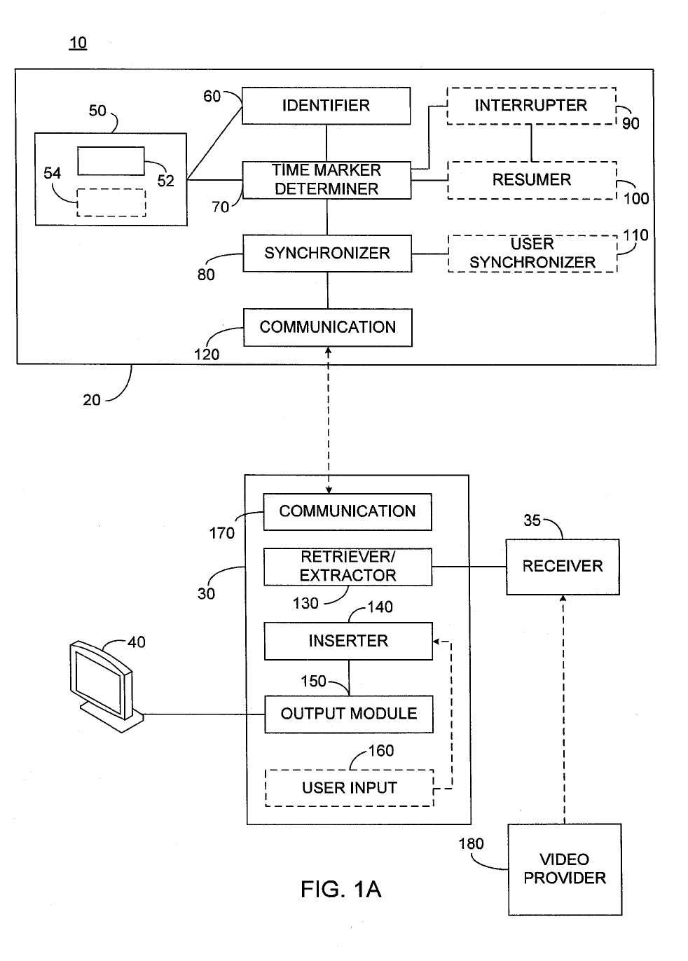

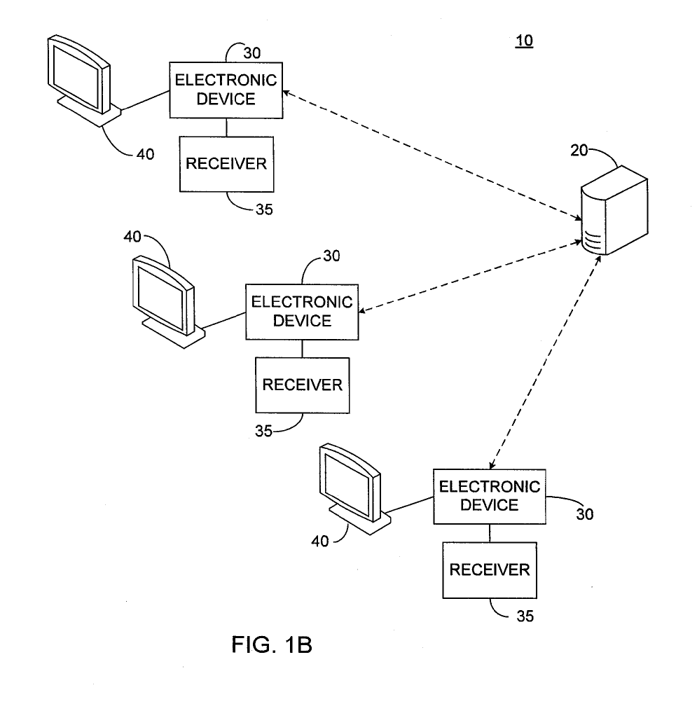

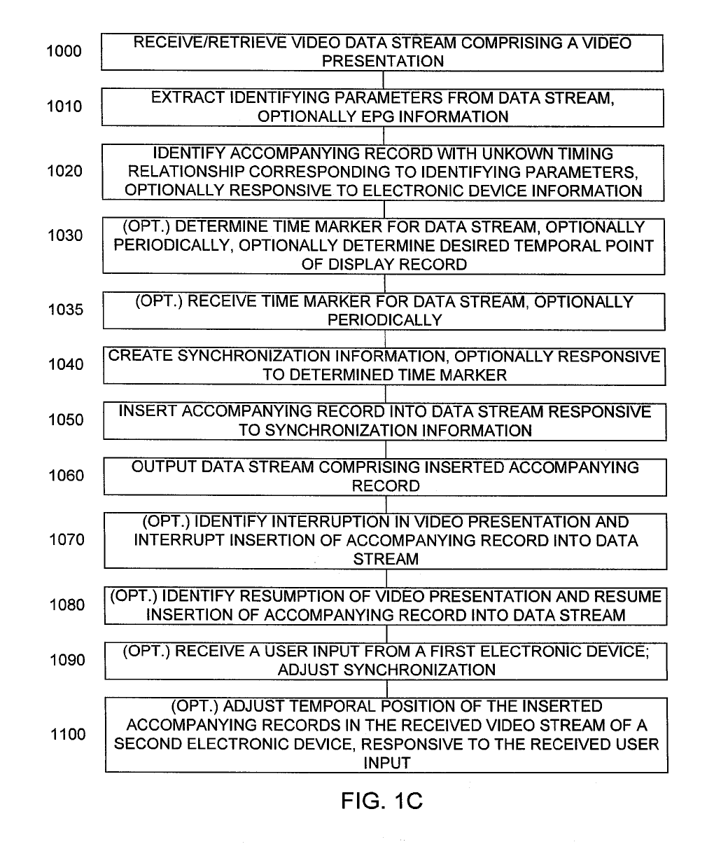

FIG. 1A illustrates a high level block diagram of a system 10 arranged to insert information into a video data stream, system 10 comprising: a server 20; an electronic device 30; a multimedia data receiver 35; and a display 40, optionally comprising a speaker (not shown). A multimedia data provider 180 is further illustrated for clarity. Server 20 comprises: a database 50, comprising an accompanying records storage 52 and an optional electronic device information storage 54; an identifier 60; a time marker determiner 70; a synchronizer 80; an optional interrupter 90; an optional resumer 100; an optional user synchronizer 110; and a communication module 120. Electronic device 30 comprises: a retriever and extractor 130; an inserter 140; an output module 150; an optional user input device 160; and a communication module 170. Identifier 60, time marker determiner 70, synchronizer 80, optional interrupter 90, optional resumer 100, optional user synchronizer 110, retriever and extractor 130, inserter 140, output module 150 and optional user input device 160 can each be implemented by any of: a dedicated functionality; computer readable instructions for a general purpose computing device or processor, the readable instructions stored on a memory associated with the respective one of server 20 and electronic device 30; dedicated hardware; and a dedicated control circuitry, without limitation. Database 50 is in one embodiment part of server 20 and in another embodiment is external of database 50, including, without limitation, a cloud computing environment in communication with server 20.

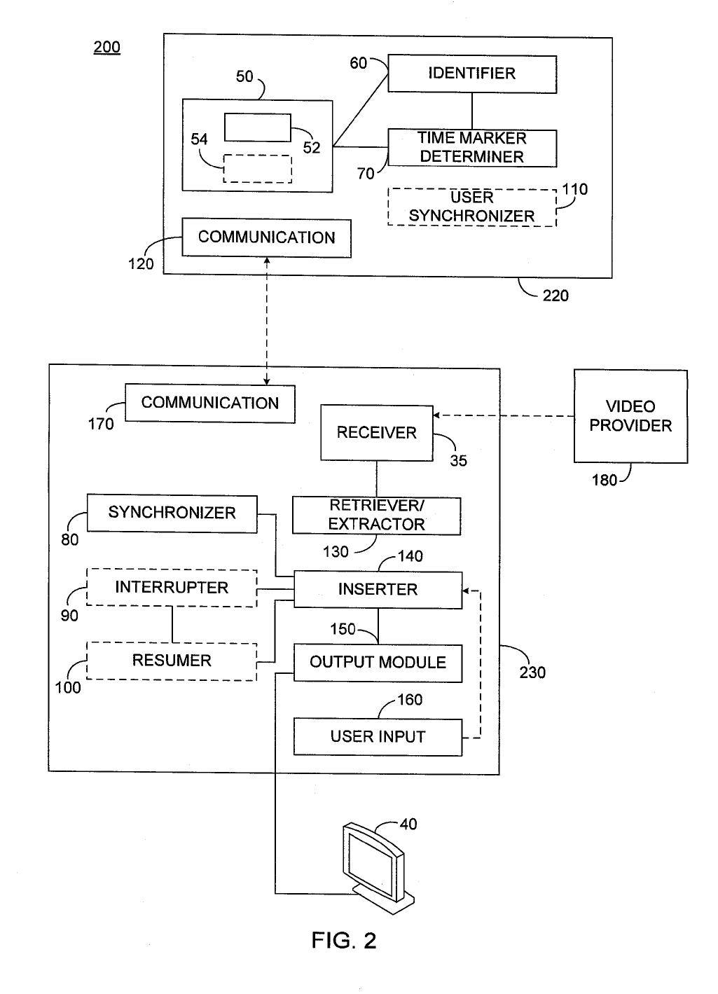

As will be described below in relation to FIG. 2, any of multimedia data receiver 35, identifier 60, time marker determiner 70, synchronizer 80, optional interrupter 90 and optional resumer 100 are in another embodiment situated within electronic device 30 instead of within server 20 without exceeding the scope. Additionally, any of retriever and extractor 130 and inserter 140 are in another embodiment situated within server 20 instead of within electronic device 30 without exceeding the scope.

FIG. 1B illustrates a high level block diagram of system 10, further illustrating server 20 and a plurality of electronic devices 30, each in communication with a respective multimedia data receiver 35 and a respective display 40. Thus, server 20 as illustrated in greater detail in FIG. 1A is illustrated in FIG. 1B in communication with a plurality of electronic devices 30. Electronic device 30 may be a portion of a device which provides additional features and/or functionality without exceeding the scope, including without limitation a general computing device.

Multimedia data receiver 35 is arranged to receive a multimedia data stream from multimedia data stream provider 180 and each electronic device 30 is arranged to receive the multimedia data stream from the respective multimedia data receiver 35. The received multimedia data stream comprises any of a plurality of multimedia data stream types such as video and music, without limitation. In one non-limiting embodiment, multimedia data stream provider 180 is a cable head end and in another embodiment multimedia data stream provider 180 is a direct broadcast satellite. In one further embodiment, multimedia data receiver 35 is arranged to receive a multimedia data stream of one or more of a plurality of technologies including, but not limited to, Internet Protocol Television (IPTV) and Digital Video Broadcasting (DVB). In another non-limiting embodiment, multimedia data stream provider 180 is a web site. In another non-limiting embodiment, multimedia data stream provider 180 is a media player having a video data file in a removable medium.

Accompanying records storage 52 is arranged to have stored thereon a plurality of accompanying records, each associated with a particular multimedia presentation. The accompanying records comprise any of a plurality of accompanying record types, such as subtitles or dubbing information. Optional electronic device information storage 54 has stored thereon information associated with one or more electronic devices 30. In one non-limiting embodiment, the information comprises any of: geographical location; language preference; and display preferences.

In one embodiment, accompanying records storage 52 is arranged to have stored thereon a plurality of accompanying records associated with each multimedia presentation. For example, a plurality of subtitle accompanying records each corresponding to a particular video presentation, each subtitle accompanying record in a different language, may be stored on accompanying records storage 52. In one further embodiment, the accompanying records associated with each video presentation are synchronized with each other, i.e. the accompanying records are adjusted such that the beginnings of the accompanying records correspond to the same temporal point in the associated video presentation. In another embodiment the time shift between the beginnings of the accompanying records are determined and stored on accompanying records storage 52.

Optional user input device 160 comprises an apparatus arranged to receive a user input, including, but not limited to: a remote control; a touch screen; a plurality of push buttons; a keyboard; a mouse; a camera; or a voice command.

Server 20 is in communication with electronic device 30 via respective communication modules 120, 170. Internal communication links with respective communication modules 120, 170 are not shown for the sake of simplicity. In an exemplary embodiment a control circuitry is provided for each of server 20 and electronic device 30, as is known to those skilled in the art, and is not shown for the sake of simplicity. Identifier 60 and time marker determiner 70 are each in communication with database 50. Identifier 60 is further in communication with time marker determiner 70. Time marker determiner 70 is further in communication with synchronizer 80, optional interrupter 90 and optional resumer 100. Optional interrupter 90 is further in communication with optional resumer 100. User synchronizer 110 is in communication with synchronizer 80. Electronic device 30 is further in communication with multimedia data receiver 35 and display 40. Preferably, retriever and extractor 130 is in communication with multimedia data receiver 35 and output module 150 is in communication with display 40. Inserter 140 is in communication with output module 150 and optional user input device 160 is optionally in communication with inserter 140.

FIG. 1C illustrates a high level flow chart of the method of operation of system 10, FIGS. 1A-1C being described together.

In operation, in stage 1000, electronic device 30 receives a multimedia data stream from multimedia data receiver 35, the multimedia data stream comprising a video presentation. In stage 1010, retriever and extractor 130 retrieves the received multimedia data stream and extracts identifying parameters from the received multimedia data stream of stage 1000. In one embodiment, the identifying parameters are extracted from a text layer of the received video data stream. In one embodiment, wherein the received multimedia data stream comprises embedded electronic program guide (EPG) information, the extracted identifying parameters are responsive to at least a portion of the EPG information. The extracted identifying parameters are then transmitted to server 20 via communication module 170 and received via communication module 120. Communication between communication module 120 and communication module 170 is preferably bidirectional and in an exemplary embodiment is implemented over the Internet, however this is not meant to be limiting in any way.

In stage 1020, identifier 60 identifies at least one of the accompanying records stored on accompanying records storage 52 which corresponds to the extracted identifying parameters of stage 1010, i.e. at least one accompanying record which is associated with the video presentation of the received multimedia data stream of stage 1000. In one embodiment, the extracted identifying parameters are compared to identifying parameters associated with each of the stored accompanying records to find the corresponding accompanying record. In another embodiment, a function of the extracted identifying parameters is compared to identifying parameters associated with each of the stored accompanying records to find the corresponding accompanying record. In one further embodiment, the function is a translation of the extracted identifying parameters. In one embodiment, identifier 60 adjusts the extracted identifying parameters according to a data cleansing algorithm such that the extracted identifying parameters may be compared to identifying parameters associated with the stored accompanying records. In one further embodiment, the data cleansing algorithm is utilized in conjunction with a stored list of titles of video presentations in a plurality of languages. In one particular embodiment, the data cleansing algorithm is arranged to remove non-relevant data, such as data added to a title.

In one embodiment, stage 1010 as described above is periodically performed and the extracted identifying parameters are compared to the accompanying records stored on accompanying records storage 52 until a corresponding accompanying record is identified. In one embodiment, the extracted identifying parameters are particular symbols from subtitles embedded in the video presentation. The extracted symbols are compared with symbols from each stored accompanying record and in the event a correspondence is identified between the extracted symbols and the symbols of a stored accompanying record, the accompanying record is identified as corresponding with the video presentation. In one particular embodiment, the extracted identifying parameters are any of: words; letters; characters; punctuation marks; the length of the lines of the displayed subtitles; and the time difference between the display of each line of the displayed subtitles.

Optionally, as described above, there may be a plurality of similar accompanying records corresponding to the extracted identifying parameters stored on accompanying records storage 52. In one embodiment, identifier 60 further identifies the desired accompanying record responsive to the identification information of electronic device 30 stored on optional electronic device information storage 54. Additionally or alternately, in one embodiment identifier 60 is further arranged to receive identification information from electronic device 30, the desired accompanying record identified responsive to the received identification information. The identification information may be transmitted by communication module 170 as part of the transmission of identifying parameters described above. Additionally or alternately, in one embodiment identifier 60 is further arranged to receive user preference information responsive to a user input at optional user input device 160, the desired accompanying record identified responsive to the received identification information. In one embodiment, a plurality of accompanying records is identified responsive to the identification information of electronic device 30.

In optional stage 1030, time marker determiner 70 is arranged to determine a time marker for the received multimedia data stream of stage 1000. In one embodiment, in the event that the extracted identification parameters of stage 1010 comprise EPG information, time marker determiner 70 is arranged to determine the amount of time elapsed from the start of the video presentation responsive to the EPG information. Additionally or alternately, in one embodiment retriever and extractor 130 is further arranged to extract embedded data from the received data stream of stage 1000 and transmit the extracted embedded data to time marker determiner 70 and time marker determiner 70 is arranged determine a time marker responsive to the extracted embedded data. In one embodiment, the embedded data is a text layer embedded in the received multimedia data stream of stage 1000. In one embodiment, the embedded data is embedded display data, and time marker determiner 70 is arranged to compare a function of the extracted display data with one of the identified at least one accompanying record of stage 1020 to determine the temporal point in the accompanying record which corresponds to the current temporal point of the received video presentation of stage 1000. Thus, the determined time marker is associated with the temporal point of the accompanying record which corresponds to the present temporal point of the video presentation.

In one embodiment, the extracted embedded data comprises subtitles for the video presentation and one of the identified at least one accompanying records comprises subtitles of the video presentation in a different language. In one further embodiment, time marker determiner 70 is arranged to translate the extracted subtitles into the language of the subtitles of the accompanying record and compare the translated subtitles to the subtitles of the accompanying record. Time marker determiner 70 then determines which portion of the subtitles of the accompanying record corresponds to the portion of subtitles extracted from the received video data stream, the end of the extracted portion of subtitles representing the current temporal point of the video presentation.

In another further embodiment, in the event that an accompanying record associated with the video presentation, comprising subtitles of the video presentation in the same language as the extracted subtitles is stored on accompanying records 52, time marker determiner 70 determines which portion of the subtitles of the accompanying record corresponds to the portion of subtitles extracted from the received video data stream, a predetermined point of the extracted portion of subtitles representing the current temporal point of the video presentation. In one particular embodiment, the predetermined point is the end. As described above, in one embodiment a plurality of accompanying records associated with the same video presentation are synchronized with each other. Therefore, by comparing the subtitles of the video presentation with one of the stored accompanying records, the time marker is determined in relation to all of the accompanying records associated with the video presentation. Advantageously, the time marker is determined by comparison of subtitles in the same language thereby allowing for synchronization of an accompanying record containing subtitles in a different language or an accompanying record containing other display material, as will be described below.

In another further embodiment, as described above, particular portions are identified from the extracted subtitles. The identified portions are compared with portions from the identified accompanying record to determine the current temporal point of the video presentation in relation to the identified accompanying record. As described above, in one embodiment the particular portions are any of: words; letters; characters; punctuation marks; the length of the lines of the displayed subtitles; and the time difference between the display of each line of the displayed subtitles.

In one embodiment, the operation of time marker determiner 70 as described above is performed periodically, each subsequent determined time marker preferably achieving greater accuracy. In one embodiment, in the event that in stage 1020 a plurality of accompanying records were identified, time marker determiner 70 is arranged to determine the temporal point in each of the identified accompanying records which corresponds to the current temporal point of the video presentation which is represented by the extracted information. In another embodiment, as will be described below, synchronizer 80 creates synchronization information for the plurality of accompanying records responsive to the determined temporal point of one of the plurality of accompanying records.

In optional stage 1035 a time marker, as described above, is transmitted to synchronizer 80 by electronic device 30. In one embodiment, the time marker was created by multimedia data stream provider 180 and embedded in the video presentation. In one embodiment, the time marker is extracted by retriever and extractor 130. In one embodiment, a time marker is periodically transmitted to synchronizer 80.

In stage 1040, synchronizer 80 is arranged to create synchronization information responsive to the determined time marker of optional stage 1030 or the received time marker of optional stage 1035. In the embodiment where time marker determiner 70 is arranged to periodically determine a time marker, synchronizer 80 is arranged to periodically create synchronization information responsive to the periodically determined time markers. In one embodiment, the created synchronization information indicates the temporal point of the identified at least one accompanying record of stage 1020 which is desired to be currently displayed. In the event that in stage 1020 a plurality of accompanying records were identified, synchronizer 80 creates synchronization information for each of the plurality of identified accompanying records. In the embodiment where the corresponding temporal point in each identified accompanying record is determined, synchronization information is created for each accompanying record responsive to the determined corresponding temporal point. In the embodiment where only the corresponding temporal point of one of the plurality of accompanying records was determined, synchronization information is created for each accompanying record responsive to the single determined corresponding temporal point. In the embodiment where, as described above, the plurality of accompanying records were synchronized with each other, the created synchronization information is preferably the same for each of the plurality of accompanying records. As described above, in one embodiment the time shifts between the various accompanying records associated with the same video presentation are determined. Additionally, as described above, in one embodiment the time marker of stage 1030 is determined in relation to an accompanying record different than the accompanying record desired to be displayed, such as an accompanying record containing subtitles in the same language of the displayed subtitles of the video presentation. In such a combined embodiment, the created synchronization information is adjusted according to the determined time shifts.

The identified at least one accompanying record of stage 1020 and the created synchronization information of stage 1040 are transmitted to electronic device 30 via communication module 120 and received by communication module 170.

In stage 1050, inserter 140 is arranged to insert the identified at least one accompanying record of stage 1020 into the received multimedia data stream of stage 1000, the insertion of the accompanying record beginning at the desired temporal point, as described above, responsive to the created synchronization information of stage 1040, responsive to the communication received by communication module 170. In the embodiment where synchronization information is periodically created, the periodically created synchronization information is periodically transmitted to inserter 140 via communication modules 120, 170. Inserter 140 adjusts the temporal point of the accompanying record being inserted into the received video data stream, responsive to the received periodic synchronization information.

In another embodiment, server 20 transmits subsequent portions of the identified at least one accompanying record, beginning at the desired temporal point, to inserter 140 via communication modules 120, 170, and inserter 140 inserts the received portions of display data into the received data stream as it is received from server 20. Preferably, the rate of transmission of the identified at least one accompanying record from server 20 is adjusted such that the synchronization of the accompanying record with the video presentation is maintained.

In stage 1060, output module 150 is arranged to output the received multimedia data stream comprising the inserted accompanying record to display 40 and to the optional speaker in the event the accompanying record is a vocal record.

In optional stage 1070, optional interrupter 90 is arranged to identify an interruption in the video presentation of the received multimedia data stream of stage 1000 by material not of the video presentation, such as a commercial message, as will be described further.

In one embodiment, as described above in relation to stage 1030, time marker determiner 70 is arranged to periodically determine a time marker for the received multimedia data stream by comparing a function of extracted display data from the received multimedia data stream with an identified accompanying record. Optional interrupter 90 monitors the comparison of stage 1030 and in the event the function of the extracted display data is not consonant with the identified accompanying record for a predetermined length of the identified accompanying record, or if no data is received from retriever and extractor 130 for a predetermined time period, optional interrupter 90 interrupts the insertion of stage 1050 by transmitting an interrupt command to inserter 140 via communication modules 120, 170. In the embodiment where inserter 140 inserts the identified at least one accompanying record responsive to synchronization information received from synchronizer 80, optional interrupter 90 thus terminates the operation of inserter 140. In the embodiment where inserter 140 inserts the portion of the identified at least one accompanying record received from server 20, optional interrupter 90 terminates the transmission of the identified at least one accompanying record from server 20 to inserter 140, and thus inserter 140 ceases operation due to the lack of input.

In another embodiment, retriever and extractor 130 is arranged to periodically extract a predetermined layer of data from the received video data stream, the predetermined layer of data comprising an indication of whether the multimedia data stream currently comprises the video presentation or material not of the video presentation. The periodically extracted layer of data is transmitted by extractor 30 to optional interrupter 90 via communication modules 120, 170. In the event that optional interrupter 90 identifies, responsive to the extracted layer of data, that an interruption in the video presentation has occurred, the insertion of the identified at least one accompanying record is terminated, as described above.

In another embodiment, an interruption in the video presentation is detected by methods known to the prior art, such as the method described in U.S. Pat. No. 5,151,788 issued on Sep. 29, 1992 to Blum, the entire contents of which are incorporated herein by reference. In the event that optional interrupter 90 identifies that an interruption in the video presentation has occurred, the insertion of the identified at least one accompanying record is terminated, as described above, until the resumption of the video presentation is detected.

In optional stage 1080, optional resumer 100 is arranged to identify a resumption of the video presentation of the received multimedia data stream of stage 1000. In the embodiment where optional interrupter 90 identified the interruption of the video presentation by monitoring the periodic comparison of stage 1030, optional resumer 100 begins monitoring the periodic comparison of stage 1030 after an interruption has been identified by optional interrupter 90. In the event the function of the extracted display data is consonant with the identified accompanying record for a predetermined length of the identified accompanying record, the insertion of the identified at least one accompanying record into the received multimedia data stream is resumed, as described above in relation to stage 1050.

In optional stage 1090, in the event a user of the electronic device of stage 1000 notices a discrepancy in the synchronization of the video presentation and the inserted accompanying record of stage 1050, i.e. the displayed data is not properly aligned with the displayed video presentation, the user may provide input at optional user input device 160 indicating the alignment correction necessary. In one embodiment, inserter 140 is arranged to adjust the synchronization of the inserted accompanying record with the video presentation responsive to the user input, and the user may continue to provide input at optional user input device 160 until the video presentation and the inserted accompanying record are properly aligned.

In another embodiment, the user input is received by synchronizer 80 via communication modules 17, 120 and synchronizer 80 is arranged to adjust the created synchronization information for the respective accompanying record of stage 1040 responsive to the received user input. As described above, the accompanying record is inserted into the received multimedia data stream of stage 1000 responsive to the created synchronization information. The user may continue to provide input at optional user input device 160 until the video presentation and the inserted accompanying record are properly aligned. In one embodiment, the user may enter an additional input indicating that the accompanying record is properly synchronized with the video presentation.

As described above, and as illustrated in FIG. 1B, a plurality of electronic devices 30 may be in communication with server 20. In optional stage 1100, in the event the identified accompanying record of stage 1020, or another accompanying record associated with the same video presentation, is being displayed to a plurality of electronic devices 30, optional user synchronizer 110 is arranged to adjust the temporal position of the inserted accompanying record of stage 1050 for each of the plurality of electronic devices 30 displaying the associated accompanying record. In the embodiment where synchronizer 80 is arranged to periodically create synchronization information, optional user synchronizer 110 is arranged to control synchronizer 80 to adjust subsequent created synchronization information responsive to the user input. In another embodiment, optional user synchronizer 110 is arranged to control inserter 140 to adjust the insertion of the accompanying record responsive to the user input, as described above.

FIG. 2 illustrates a high level block diagram of a system 200 arranged to insert information into a video data stream, system 200 comprising: a server 210; an electronic device 220; and a display 40. Multimedia data provider 180 is further illustrated as described above in relation to FIG. 1A. Server 220 comprises: a database 50, comprising an accompanying records storage 52 and an optional electronic device information storage 54; an identifier 60; a time marker determiner 70; an optional user synchronizer 110; and a communication module 120. Electronic device 230 comprises: a multimedia data receiver 35; a synchronizer 80; an optional interrupter 90; an optional resumer 100; a retriever and extractor 130; an inserter 140; an output module 150; an optional user input device 160; and a communication module 170. Multimedia data receiver 35, identifier 60, time marker determiner 70, synchronizer 80, optional interrupter 90, optional resumer 100, optional user synchronizer 110, retriever and extractor 130, inserter 140 and output module 150 can each be implemented by any of: a dedicated functionality; computer readable instructions for a general purpose computing device or processor, the readable instructions stored on a memory associated with the respective one of server 220 and electronic device 230; dedicated hardware; and a dedicated control circuitry, without limitation. Database 50 is in one embodiment part of server 210 and in another embodiment is external of database 50, including, without limitation, a cloud computing environment in communication with server 220.

Server 220 is in communication with electronic device 230 via respective communication modules 120, 170. Identifier 60 and time marker determiner 70 are each in communication with database 50. Internal communication links with respective communication modules 120, 170 are not shown for the sake of simplicity. In an exemplary embodiment a control circuitry is provided for each of server 220 and electronic device 230, as is known to those skilled in the art, and is not shown for the sake of simplicity. Identifier 60 and time marker determiner 70 are each in communication with database 50. Identifier 60 is further in communication with time marker determiner 70. Synchronizer 80 is in communication with inserter 140. Optional interrupter 90 is in communication with optional resumer 100 and with inserter 140. Resumer 100 is further in communication with inserter 140. Retriever and extractor 130 is in communication with multimedia data receiver 35 and multimedia data receiver 35 is in communication with a multimedia data provider 180. Inserter 140 is further in communication with output module 150 and output module 150 is in communication with display 40.

The operation of system 200 is in all respects similar to the operation of system 10 of FIGS. 1A-1C, and in the interest of brevity will not be further described, differing primarily in that certain functions are performed by electronic device 230 which in FIG. 1A are performed by server 20.

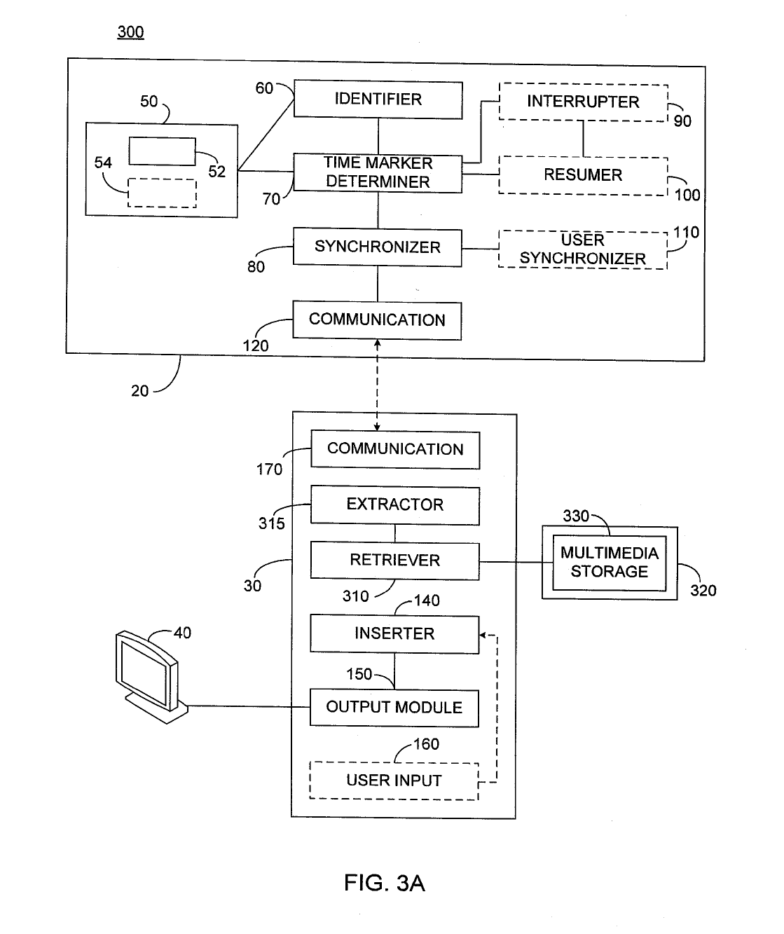

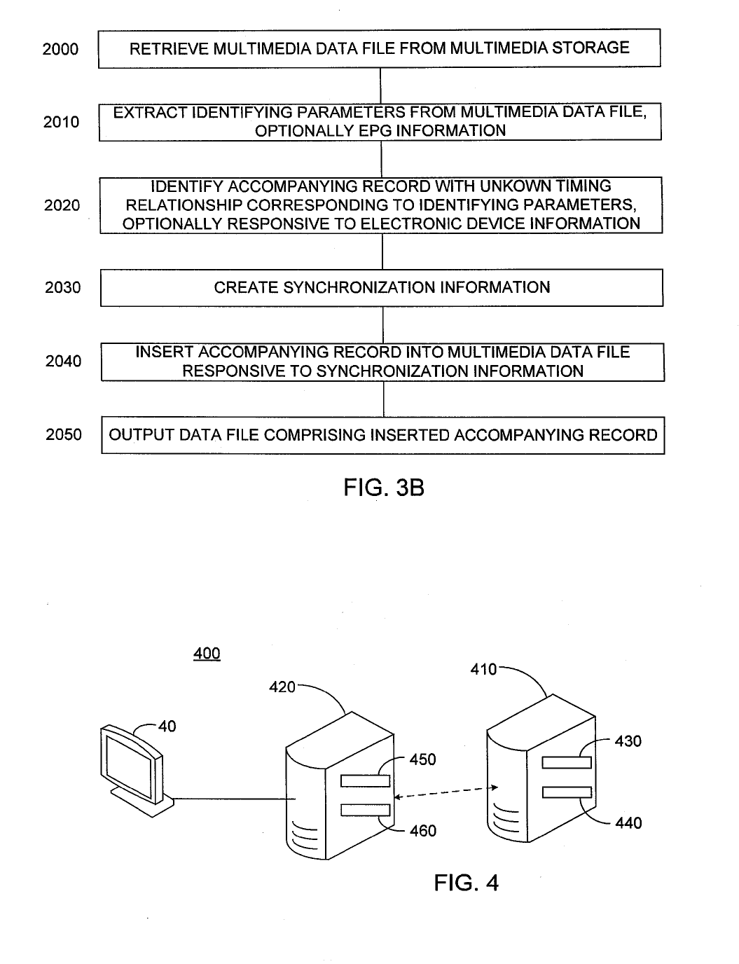

FIG. 3A illustrates a high level block diagram of a system 300 arranged to insert information of an accompanying record into a multimedia data file and FIG. 3B illustrates a high level flow chart of the operation of system 300, FIGS. 3A-3B being described together. System 300 is in all respects similar to system 10 of FIG. 1A, with the exception that a retriever 310 and an extractor 315 is provided in electronic device 30 in place of retriever and extractor 130, and multimedia data receiver 35 is replaced with an electronic device 320 comprising a multimedia storage 330. Retriever 310 is in communication with multimedia storage 330 and extractor 315 is in communication with retriever 310. Multimedia storage 330 contains therein one or more multimedia files, such as video files and music files.

In stage 2000, retriever 310 retrieves a multimedia data file from multimedia storage 330. In stage 2010, extractor 315 is arranged to extract identifying parameters from the retrieved multimedia data file of stage 2000 and transmit the identifying parameters to server 20, as described above in relation to stage 1010 of FIG. 1C. In stage 2020, identifier 60 is arranged to identify an accompanying record stored on accompanying records storage 52 corresponding to the retrieved multimedia data file of stage 2000, responsive to the extracted identifying parameters of stage 2010, as described above in relation to stage 1020. As described above, in the event a plurality of accompanying records are identified as corresponding to the retrieved multimedia data file, identifier 60 is arranged to identify a particular accompanying record according to identifying information of electronic device 30 or electronic device 320 stored on optional electronic device information storage 54. The timing relationship between the identified accompanying record and the retrieved multimedia data file is typically, a priori, unknown. For example, the multimedia data file may contain a multimedia presentation and the identified accompanying record may begin at a point in time of the multimedia presentation which is not the beginning.

In stage 2030, synchronization information is created for the identified accompanying record of stage 2020, as described above in relation to stage 1040 and optional stages 1020-1030. In stage 2040, the identified accompanying record of stage 2020 is inserted by inserter 140 into the retrieved multimedia data file of stage 2000 responsive to the created synchronization of stage 2030. In one embodiment, the accompanying record is inserted in the multimedia data file during the output thereof, as described above in relation to the data stream of stage 1050. In another embodiment, the entire accompanying record is inserted into the multimedia data file prior to output thereof. In stage 2050, the multimedia file comprising the inserted accompanying record of stage 2040 is output by output module 150 to display 40 and to the optional speaker in the event the accompanying record is a vocal record. In one embodiment, optional stages 1070-1100 are performed, as described above. In one embodiment, the above stages may be accomplished at any point during the output of the retrieved multimedia data file. Particularly, a portion of the data from the multimedia data file may be output to display 40 and an accompanying record is identified for the remaining portion of the data.

FIG. 4 illustrates a high level schematic diagram of a system 400 arranged to insert information into multimedia data. System 400 comprises: a server 410, comprising a processor 430 and a memory 440; an electronic device 420, comprising a processor 450 and a memory 460; and a display 40. Memory 440 has stored thereon instructions, processor 430 being arranged to execute the stored instructions. Memory 460 has stored thereon instructions, processor 450 being arranged to execute the stored instructions. The arrangement and operation of system 400 is in all respects similar to any of systems 10, 200, and 300, described above, with the exception that processors 430 and 450 are arranged to perform the operations of one or more of the above described functionalities, modules and components of systems 10, 200 and 300.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

1. A non-transitory computer readable medium having instructions stored thereon, which, when executed by one or more processors, causes the one or more processors to perform operations, the operations comprising:
retrieving multimedia data from at least one multimedia storage device;
extracting identifying parameters from said retrieved multimedia data;
responsive to said extracted identifying parameters, identifying a particular one of a plurality of accompanying records associated with said retrieved multimedia data;
creating synchronization information for said identified accompanying record;
inserting said identified particular accompanying record into said retrieved multimedia data responsive to said created synchronization information; and
outputting said retrieved multimedia data comprising said inserted identified particular accompanying record.

2. The non-transitory computer readable medium of claim 1, wherein the multimedia data comprises a multimedia data stream being received by the at least one multimedia storage device,
wherein said extracting identifying parameters, said identifying the particular one of the plurality of accompanying records, said creating synchronization information, said inserting and said outputting are contemporaneous with the receiving of the multimedia data stream by the at least one multimedia storage device.

3. The non-transitory computer readable medium of claim 1, wherein the at least one multimedia storage device comprises a first multimedia storage device and a second multimedia storage device different from the first multimedia storage device, said retrieving comprising retrieving multimedia data from each of the first and second multimedia storage devices, the operations further comprising:
receiving a user input from an electronic device, the electronic device comprising the first multimedia storage device; and
adjusting the temporal position of said inserted accompanying record in the retrieved multimedia data from the second multimedia storage device responsive to said received user input.

4. The non-transitory computer readable medium of claim 1, wherein the operations further comprise receiving a time marker for said retrieved multimedia data, and
wherein said creating synchronization information is responsive to said received time marker.

5. The non-transitory computer readable medium of claim 1 wherein the operations further comprise determining a time marker for said retrieved multimedia data, and
wherein said creating synchronization information is responsive to said determined time marker.

6. The non-transitory computer readable medium of claim 5, wherein said retrieved multimedia data comprises embedded display information and wherein said determining the time marker is responsive to said embedded display information.

7. The non-transitory computer readable medium of claim 5, wherein said determining a time marker is performed periodically.

8. The non-transitory computer readable medium of claim 1, wherein said retrieved multimedia data comprises a video presentation and wherein in the event the video presentation is interrupted with material not of the video presentation, the operations further comprise:
identifying the interruption in the video presentation;
interrupting said inserting of said identified particular accompanying record into said retrieved multimedia data responsive to said identified interruption;
identifying the resumption of the video presentation; and
resuming said inserting of said identified particular accompanying record responsive to said identified resumption.

9. The non-transitory computer readable medium of claim 1, wherein the operations further comprise receiving information associated with the at least one multimedia storage device, and
wherein said identifying the particular one of the plurality of accompanying records is further responsive to said received information associated with the at least one multimedia storage device.

10. The non-transitory computer readable medium of claim 1, wherein said retrieved multimedia data comprises embedded electronic program guide information and wherein said extracting identifying parameters from said retrieved multimedia data comprises extracting a portion of said embedded electronic program guide information.

11. A method of inserting information into multimedia data, the method comprising:
retrieving multimedia data from at least one multimedia storage device;
extracting identifying parameters from said retrieved multimedia data;
responsive to said extracted identifying parameters, identifying a particular one of a plurality of accompanying records associated with said retrieved multimedia data;
creating synchronization information for said identified accompanying record;
inserting said identified particular accompanying record into said retrieved multimedia data responsive to said created synchronization information; and
outputting said retrieved multimedia data comprising said inserted identified particular accompanying record.

12. The method of claim 11, wherein the multimedia data comprises a multimedia data stream being received by the at least one multimedia storage device,
wherein said extracting identifying parameters, said identifying the particular one of the plurality of accompanying records, said creating synchronization information, said inserting and said outputting are contemporaneous with the receiving of the multimedia data stream by the at least one multimedia storage device.

13. The method of claim 11, wherein the at least one multimedia storage device comprises a first multimedia storage device and a second multimedia storage device different from the first multimedia storage device, said retrieving comprising retrieving multimedia data from each of the first and second multimedia storage devices, the method further comprising:
receiving a user input from an electronic device, the electronic device comprising the first multimedia storage device; and
adjusting the temporal position of said inserted accompanying record in the retrieved multimedia data from the second multimedia storage device responsive to said received user input.

14. The method of claim 11, further comprising:
receiving a time marker for said retrieved multimedia data,
wherein said creating synchronization information is responsive to said received time marker.

15. The method of claim 11, further comprising:
determining a time marker for said retrieved multimedia data,
wherein said creating synchronization information is responsive to said determined time marker.

16. The method of claim 15, wherein said retrieved multimedia data comprises embedded display information and wherein said determining the time marker is responsive to said embedded display information.

17. The method of claim 15, wherein said determining a time marker is performed periodically.

18. The method of claim 11, wherein said retrieved multimedia data comprises a video presentation and wherein in the event the video presentation is interrupted with material not of the video presentation, the method further comprises: identifying the interruption in the video presentation;
interrupting said inserting of said identified particular accompanying record into said retrieved multimedia data responsive to said identified interruption;
identifying the resumption of the video presentation; and
resuming said inserting of said identified particular accompanying record responsive to said identified resumption.

19. The method of claim 11, further comprising:
receiving information associated with the at least one multimedia storage device,
wherein said identifying the particular one of the plurality of accompanying records is further responsive to said received information associated with the at least one multimedia storage device.

20. The method of claim 11, wherein said retrieved multimedia data comprises embedded electronic program guide information and wherein said extracting identifying parameters from said retrieved multimedia data comprises extracting a portion of said embedded electronic program guide information.

21. A system arranged to insert information into multimedia data, the system comprising:
a retriever in communication with at least one multimedia storage device having stored thereon multimedia data, said retriever arranged to retrieve multimedia data from the at least one multimedia storage device;
an extractor arranged to extract identifying parameters from said retrieved multimedia data;
an identifier in communication with an accompanying record storage device having stored thereon a plurality of accompanying records, said identifier arranged to, responsive to said extracted identifying parameters, identify a particular one of said plurality of accompanying records associated with said retrieved multimedia data, wherein the timing relationship between said identified accompanying record and said retrieved multimedia data is unknown;
a synchronizer arranged to create synchronization information for said identified accompanying record;
an inserter arranged to insert said identified particular accompanying record into said retrieved multimedia data responsive to said created synchronization information; and
an output module arranged to output said retrieved multimedia data comprising the inserted accompanying record.

22. The system of claim 21, further comprising:
a processor;
a memory, having instructions stored thereon,
wherein said processor is arranged to execute the instructions stored on said memory thereby performing the operations of one of said retriever, extractor, identifier, synchronizer, inserter and output module.

23. The system of claim 21, wherein the multimedia data comprises a multimedia data stream being received by the at least one multimedia storage device,
wherein said extraction of identifying parameters, said identification of the particular accompanying record, said creation of synchronization information, and said insertion of said identified particular accompanying record and said outputting are contemporaneous with the receiving of the multimedia data stream by the at least one multimedia storage device.

24. The system of claim 21, further comprising:
a server comprising the accompanying record storage device,
wherein said communication with the accompanying record storage device comprises communication with said server.

25. The system of claim 24, wherein the at least one multimedia storage device comprises a plurality of multimedia storage devices, the system further comprising:
a plurality of electronic devices, each electronic device comprising a particular one of the plurality of the multimedia storage devices; and
a user synchronizer arranged to:
receive a user input from a first of said plurality of electronic devices; and
adjust the temporal position of said inserted accompanying record in the received video stream of a second of said plurality of electronic devices responsive to said received user input, said second of said plurality of electronic devices different from said first of said plurality of electronic devices.

26. The system of claim 21, wherein said retriever is arranged to retrieve from the at least one multimedia storage device a time marker for said retrieved multimedia data, and
wherein said synchronizer is responsive said retrieved time marker.

27. The system of claim 21, further comprising:
a time marker determiner arranged to determine a time marker for said retrieved multimedia data,
wherein said synchronizer is responsive to said determined time marker.

28. The system of claim 21, wherein said retrieved multimedia data comprises embedded display information and wherein said time marker determiner is responsive to said embedded display information.

29. The system of claim 28, wherein said time marker determiner is arranged to periodically determine the time marker for said received video data stream.

30. The system of claim 21, wherein said retrieved multimedia data received multimedia data stream comprises a video presentation and wherein the system further comprises:
an interrupter; and
a resumer,
wherein in the event the video presentation is interrupted with material not of the video presentation said interrupter is arranged to:
identify the interruption in the video presentation; and
interrupt said insertion of said identified particular accompanying record into said retrieved multimedia data, and
wherein at the cessation of the interruption of the video presentation, said resumer is arranged to:
identify the cessation of the interruption in the video presentation, and
resume said insertion of said identified particular accompanying record into said retrieved multimedia data.

31. The system of claim 21, wherein said retrieved multimedia data comprises embedded electronic program guide information and wherein said extractor is arranged to extract a portion of said embedded electronic program guide information.
